(19) United States
(12) Patent Application Publication
(10) Pub. No.: US 2014/0260830 A1
(43) Pub. Date: Sep. 18, 2014

(54) SEAL-BREAK PLIERS

(71) Applicant: SRM, LLC dba Holloway America, Springfield, MO (US)

(72) Inventors: Charles Patrick McKee, (US); David E. Simpson, Springfield, MO (US)

(73) Assignee: SRM, LLC dba Holloway America, Springfield, MO (US)

(21) Appl. No.: 14/210,983

(22) Filed: Mar. 14, 2014

Related U.S. Application Data
(60) Provisional application No. 61/782,899, filed on Mar. 14, 2013.

(51) Int. Cl. B25B 7/02

(52) U.S. Cl. CPC B25B 7/02
USPC 81/426.5

(57) ABSTRACT

A seal-break pliers used to separate components in food processing, chemical, or pharmaceutical manufacturing or processing system. The seal-break pliers including a first section and a second section. Each section includes a handle, a head section, and a transition section disposed and angularly orientated between the handle and the head section. A fastener pivotally couples the first section to the second section such that displacing the first and second handles toward each other results in a relative movement of the head sections toward each other. Each head portion includes a guide projection, a flange notch adjacent to the guide projection, and a wedge projection adjacent to the flange notch. The flange notch is configured to receive a portion of the flange of a component. The wedge projection may include a pointed edge proximate the flange notch and an inclined surface extending away from the pointed edge.

### CROSS-REFERENCE TO RELATED APPLICATION

This application claims the benefit of U.S. Provisional Patent Application No. 61/782,899, filed Mar. 14, 2013, the entire disclosure of which is hereby incorporated by reference.

### FIELD OF THE INVENTION

This present invention relates to a tool used to effectively and safely separate pipe sections and instruments connected by clamp connections used in high-temperature and high pressure food processing, or pharmaceutical or chemical manufacturing or processing operations, which does not damage the connection flanges of the elements so that such sections can be re-used.

### BACKGROUND OF THE INVENTION

Food, chemical and pharmaceutical processing and manufacturing equipment require a variety of temperatures and often large pressure variations. Accordingly, specialty tanks and piping systems for conveying and mixing ingredients and other components have been developed. Because steps often require high temperature and pressure, the connections used to join pipe connections and instruments to the system are often clamped connections. A seal or o-ring may also be present between the components. The clamping force constricts separation of the pipe sections or components due to high pressures and the seal is compressed between the two sections providing a leak-resistant connection. Because of the high standards and high-performance requirements of the components and the machined connections, these components have a high purchase cost. As such, an operational life of long duration is desired for these high-cost components.

The entire conveyance and processing systems may regularly be disassembled for cleaning or sterilization because sterility and contamination are pressing considerations in the food processing and pharmaceutical industries. In addition, the systems need to be reconfigured for the production of different products. Because of the high temperature and pressure combined with the compression force applied between the elements due to the compression or clamped connection, the pipe sections and components can become bound together and very difficult to separate under normal human force. As such, technicians were forced to use what they had on hand to separate the connections, such as wooden hammers, screw drivers, pry-bars, or other non-use specific tools. The use of these tools often resulted in the successful separation of the two components, but also tended to damage the joining surfaces of the flanges of the components therefore rendering them incapable of being re-used for such high-temperature and high-pressure situations.

Thus, there is a need in the art for a tool that can be used by technicians to separate pipe sections, instruments, or other components that have been bound by a clamp connection (1) in a short period of time, (2) with relative ease of use, and (3) resulting in minimal to no damage to the connection flange in order to prolong the operational life of each component piece.

### SUMMARY OF THE INVENTION

The present invention is directed toward a seal-break pliers for separating components in food processing, chemical, or pharmaceutical manufacturing or processing system. The present seal-break pliers may comprise a first section and second section pivotally coupled by a fastener. The first section may include a first handle, a first head section, and a first transition section. The first transition section may be disposed and angularly orientated between the first handle and the first head section. The second section similarly may include a second handle, a second head section, and a second transition section, wherein the second transition section may be disposed and angularly orientated between the second handle and the second head section. The fastener pivotally couples the first transition section of a first section to the second transition section of the second section such that displacing the first and second handle towards each other results in a relative movement of the head sections toward each other.

Further, each of the first and the second head portions each include a guide projection, a flange notch adjacent to the guide projection, and a wedge projection adjacent to the flange notch. The wedge projection may include a pointed edge proximate the flange notch and an inclined surface extending away from the pointed edge and toward an outer edge of the head section. The inclined surface intersects a second surface of the head section at an angle. The angle may be in a range between about thirty (30) degrees and sixty (60) degrees, or may be around forty-five (45) degrees.

The present seal-break pliers may include the guide projection, the flange notch, and the wedge projection of each head section sharing a common radius center point. Further, the radius to the inner edge of the guide projection may be less than the radius to the pointed edge of the wedge projection. In addition, each flange notch may include a thickness and depth capable to receive a portion of a flange of a component.

Other aspects and advantages of the present invention will be apparent from the following detailed description of the preferred embodiments and the accompanying drawing figures.

### BRIEF DESCRIPTION OF THE SEVERAL VIEWS OF THE DRAWINGS

The accompanying drawings form a part of the specification and are to be read in conjunction therewith, in which like reference numerals are employed to indicate like or similar parts in the various views.

FIG. 1 is a section view of two pipe sections connected with a clamped connection in accordance with the teachings of the present disclosure;

FIG. 2 is a perspective view of an embodiment of the seal-break pliers of the present invention configured to separate pipe sections in accordance with the teachings of the present disclosure;

FIG. 3A is a side view and FIG. 3B is a bottom view of a first section of the seal-break pliers of the embodiment in FIG. 2;

FIG. 4A is a side view and FIG. 4B is a bottom view of a second section of the seal-break pliers of the embodiment in FIG. 2;

FIG. 5 is a section view of the seal-break pliers of FIG. 2 about to engage the two pipe sections of the clamped connection of FIG. 1 in accordance with the teachings of the present disclosure; and

FIG. 6 is a section view of the seal-break pliers of FIG. 2 engaging the two pipe sections of the clamped connection of FIG. 1 in accordance with the teachings of the present disclosure.

### DETAILED DESCRIPTION OF THE INVENTION

The following detailed description of the present invention references the accompanying drawing figures that illustrate specific embodiments in which the invention can be practiced. The embodiments are intended to describe aspects of the present invention in sufficient detail to enable those skilled in the art to practice the invention. Other embodiments can be utilized and changes can be made without departing from the spirit and scope of the present invention. The present invention is defined by the appended claims and, therefore, the description is not to be taken in a limiting sense and shall not limit the scope of equivalents to which such claims are entitled.

As shown in FIG. 1, a clamped connection 100 comprising a first component 102, a second component 104, and a compression clamp 106 as known in the art. First component 102 comprises a tube section 108 and a flange 110. Second component similarly comprises a tube section 112 and a flange 114. One of the first or second components 102 or 104 may be an instrument that does not include a tube section, but rather the instrument having a flange which can be connected to the system through the same clamped connection. In addition, first component 102 or second component 104 may be a blank-cap (not shown) which is a termination end for a pipe wherein the blank-cap is a flat disk wherein the outer periphery is shaped like flanges 110 and 114 which are shown and further described below. The blank-caps are generally connected to the system through a clamped connection similar to that shown in FIG. 1. As shown, flanges 110 and 114 respectively include a connection bearing surface 116a and 116b, an inclined upper surface 118a and 118b, and a seal member or o-ring 120 disposed between bearing surfaces 116a and 116b to seal the connection. As shown, compression clamp 106 constricts in a radial direction about the flanges 110 and 114 and engages the respective inclined surfaces 118a and 118b thereof. This constriction upon an angled surface results in an axial directed force component compressing the bearing surface 116a and 116b against each other and compressing seal member 120 to seal the connection. The configuration of clamp 106 resists movement of components 102 and 104 away from each other as shown.

As stated above, over time, the seal or o-ring 120 often adheres to or otherwise binds to the first component 102 and the second component 104 due to the connection compression force, and/or the operating pressure and temperatures. In such cases, a technician may need additional leverage to separate the component pieces. As shown in FIG. 6, an embodiment of the seal-break pliers 10 of the present invention effectively separates the components without damaging any portions of the flange. This is important because it allows these components to be reused when the equipment is reassembled after cleaning or sanitizing, or in subsequent configurations of processing equipment which saves replacement costs. This was not always possible.

Turning back to FIG. 2, the seal-break pliers 10 of the present invention may comprise a first section 12 and a second section 14 pivotally connected by a fastener 16. First section 12 comprises a first handle 18, a first head portion 20 and a first transition section 22 disposed between first handle 18 and head portion 20. Second section 14 also comprises a second handle 24, a second head portion 26, and a second transition section 28 disposed between second handle 24 and second head portion 26. As shown, second section 14 is pivotally coupled to first section 12 such that head portion 26 aligns with head portion 20 in an opposing arrangement. Because first section 12 and second section 14 are a relating pair and act in concert to help separate the pipe sections, they will generally have similar and cooperating shapes and dimensions. However, the configurations of each shape may be different if required to perform the intended function of separating components in a food processing or pharmaceutical or chemical manufacturing or processing system.

As shown in FIGS. 3A, an embodiment of first section 12 of the seal-break pliers 10 includes a handle section 18 having a length L1 between a first end 32 and a second end 34, wherein the length will vary depending upon the amount of leverage desired to assist technicians in closing the head portions 20 and 26 about a pipe section. Length L1 may be any length, but is preferably between about three (3) and about eight (8) inches. Lengths up to and exceeding twelve (12) to eighteen (18) inches are within the scope of the present invention.

As shown in FIG. 3A, handle 18 may also have a width W1 which can be any dimension, but is preferably between around one-quarter (¼) and two (2) inches. Width W1 may also vary along the length L1 of handle 18. First transition section 22 extends away from second end 34 of handle section 18 and may be angularly orientated at an angle β. Angle β may be any angle between zero (0) and ninety (90) degrees, but is preferably in a range between about thirty (30) and about sixty (60) degrees. In one embodiment, angle β is about forty-five (45) degrees. Transition section 22 extends a horizontal length component L3 from second end 34 of first handle 18 wherein the actual length of transition section 22 can be determined using the length L3 and the angle β. Transition section 22 has a first end 36 and a second end 38. First end 36 of transition section 22 is proximate second end 34 of handle 18. Transition section 22 terminates at an outer surface 39a of head section 20 wherein transition section 22 also includes a bend 41 at an angle γ to orientate head section 20 with respect to handle 18. In one embodiment, head section 20 may be orientated substantially parallel to handle 18. Angle γ may be any angle between zero (0) and ninety (90) degrees, but is preferably in a range between about thirty (30) and about sixty (60) degrees. In one embodiment, angle γ is about forty-five (45) degrees.

Transition section 22 includes an aperture 40 configured to receive fastener 16. Aperture 40 corresponds with the pivot point of seal-break pliers 10 and is located at a lever arm distance LA₁ from an end 32 of handle 18. Further, as shown in FIG. 3A, transition section 22 has a width W2 over substantially the entire length thereof. A notch 42 may be cut-out of width W2 of transition section 22 proximate second end 38 and head section 20 to accommodate the intended or a desired range of motion of head section 20.

As shown in FIG. 3B, handle section 18 has a thickness Ti defined by a first side 44 and a second side 46 of handle section 18. Section 12 of seal-break pliers 10 may be machined from a section of metal plate, so thickness T1 may correspond to the selected nominal plate thickness. Alternatively, thickness T1 may be selected as necessary by a person of skill in the art based upon the material of the seal-break pliers and the bending strength required to apply the desired separating force. For example, one embodiment includes a thickness T1 of three-fourths (¾) inch, but an embodiment may include thicknesses T1 preferably between around one-fourth (¼) inch to around two (2) inches. As further shown, transition section 22 has a thickness T2 defined by first side 44 of first section 12 and a third side 47 of transition section 22 wherein T2 is shown being less than T1. However, T2 may be equal to or greater than T1. In one embodiment, T2 is around one-half of T1 in order to properly align head portion 20 and 26 when the seal-break pliers 10 is assembled.

As shown in FIGS. 4A, second section 14 includes a handle section 24 having a length L4 between a first end 48 and a second end 50, wherein the length will vary depending upon the amount of leverage desired to assist technicians in closing the head portions 20 and 26 about a pipe section. Length L4 is preferably between about three (3) and about eight (8) inches, although lengths up to and exceeding twelve (12) to eighteen (18) inches are within the scope of the present invention.

As shown in FIG. 4A, handle 24 may also have a width W4 which can be any dimension, but is preferably between around one-fourth (¼) inch and two (2) inches. Width W4 may also vary along the length L4 of handle 24. Transition section 28 extends away from second end 50 of handle section 24 and is angularly orientated at an angle β. Angle β may be any angle between zero (0) and ninety (90) degrees, but is preferably in a range between about thirty (30) and about sixty (60) degrees. In one embodiment, angle β is about forty-five (45) degrees. Transition section 28 extends a horizontal length component of L6 from second end 50 of second handle 24 to second end 54 of transition section 28 wherein the actual length of transition section 28 can be determined using the length L6 and the angle β. Transition section 28 has a first end 52 and a second end 54. First end 52 of transition section 28 is proximate second end 50 of handle 24. Transition section 28 terminates at an outer surface 39b of head section 28 wherein transition section 28 includes a bend 56 at an angle γ to orientate head section 20 substantially parallel to handle 18. Angle γ may be any angle between zero (0) and ninety (90) degrees, but is preferably in a range between about thirty (30) and about sixty (60) degrees. In one embodiment, angle γ is about forty-five (45) degrees.

Transition section 28 includes an aperture 58 through the entire piece wherein aperture 58 is sized for fastener 16 to pass through. Aperture 58 corresponds with the pivot point of seal-break pliers 10 and is located at a lever at n distance LA₃ from first end 48 of handle 18. Further, as shown in FIG. 4A, transition section 28 has a width W5 over substantially the entire length thereof wherein a notch 60 may be cut-out of transition section 28 proximate second end 54 to accommodate the intended range of motion of head section 26.

As shown in FIG. 4B, handle section 24 has a thickness T7 defined by a first side 62 and a second side 64. Section 14 of seal-break pliers 10 may be machined from a metal plate, so thickness T7 may be any nominal plate thickness. Alternatively, thickness T7 may be selected as necessary by a person of skill in the art to provide bending strength required to apply the desired separating force. For example, one embodiment includes a thickness T7 of three-quarters (¾) inch, but an embodiment may include thicknesses T7 preferably between one-quarter (¼) inch and two (2) inches. As further shown, transition section 28 has a thickness T8 defined by a third side 65 and second side 64 wherein T8 is less than T7. In one embodiment, T8 is around one-half of T7 to properly align head portion 20 and 26 when the pliers 10 is assembled. In one embodiment, thickness T7 may be substantially the same as thickness T1 and thickness T8 may be substantially the same as T2.

In one embodiment of the present seal-break pliers, head sections 20 and 26 are substantially identical in size, shape and configuration, however, they are connected to second ends 38 and 54 of transition sections 22 and 28 respectively at opposite sides of the width of surfaces 39a or 39b of the respective head section so that when first and second sections 12 and 14 of seal-break pliers 10 are assembled and pivot relative to each other, the respective components of their respective head sections 20 and 26 are in aligned opposite arrangement, or otherwise “line-up.” As such, all of the elements of head sections 20 and 26 will be called out using the same labels with the elements of head portion 20 being identified with an “a” and the elements of head portion 26 being identified with a “b.” Head section 20 has length L₂ and head section 26 may have a length L₅ which may vary and which will be selected or determined in consideration of the radius of the flange for the pipe sections or other components to be separated. Head sections 20 may be in an arched or circular shape and defined by a similar chord length L2 as shown in FIG. 3A and head section 26 may be in an arched or circular shape and defined by a similar chord length L5 as shown in FIG. 4A.

As further shown in FIG. 3A, head portion 20 has an outer surface 39a defined by a radius R1 and a width W3 in a radial direction inward from outer surface 39a. As shown in FIG. 3B, head section 20 has an overall thickness T3 between a first surface 73a and a second surface 75a of head section 20 that may match T1 of the handle as shown or, alternatively, may be more or less than T1. Head section 20 is comprised of at least three elements: a guide projection 66a, a flange notch 68a, and a connection wedge 70a, all of which extend radially inward from the outer surface 39a. Guide projection 66a extends the furthest radially inward from outer surface 39a and its inner edge 72a is defined by radius R2. Guide projection 66a has a thickness of T4 that may be any thickness between about one-fourth (¼) to about three-fourths (¾) of T3. The inner edge 72a and outer edge 39a of guide projection 66a define width W3.

Flange notch 68a is configured to receive the flange of a high temperature-high pressure processing system component or a portion thereof for the applicable flange size for the diameters of components being separated. Flange notch 68a has a thickness or width T5 that may be any thickness between about one-fourth (¼) to about three-fourths (¾) of T3. Flange notch 68a has an interior surface 74a that is defined by a radius R3 as shown in FIGS. 3A. The distance from the inner surface 72a of guide projection 66a to interior surface 74a may be also called the depth of the flange notch 68a.

Connection wedge 70a begins at a pointed edge 76a and has an inclined surface 78a extending from the pointed edge 76a upward and back toward the outer edge 39a at an angle α. Angle α may be any angle between zero (0) and ninety (90) degrees, preferably in a range between about thirty (30) to about sixty (60) degrees. A pointed edge 76a is defined at a radius R4 and may be proximate the flange notch 66a. For purposes of this disclosure and interpreting the claimed invention, any reference to pointed edge 76 shall include a sharp point or a rounded edge profile. Connection wedge 70a has a thickness or width T6 that may be any thickness between about one-fourth (¼) to about three-fourths (¾) of T3. When combined, T4, T5, and T6 may add up to T3. In one embodiment, radiuses R1, R2, R3, and R4 may share a common radius center point 80a and, therefore, may be substantially concentric. Radius center point 80a may be positioned a length LR₁ from end 32 of handle 18, and a height H3 from an inner side 82 of handle 18 of first section 12. Handle 18 also includes an outer side 83 wherein inner side 82 and outer side 83 defines width W1.

As shown in FIG. 3A, radius center point 80a is also positioned a length LA₂ from a center point 86 of aperture 40. As further shown in FIG. 3A, head portion 20 includes a first end 90a and a second end 92a. As shown, first end 90a may have an angular orientated surface, at an angle A1, to a line parallel to or otherwise defined by inner side 82 of handle 18. Angle A1 may be any angle between about zero (0) degrees and about forty-five (45) degrees, preferably between about five (5) and about twenty (20) degrees. Similarly, as shown in FIG. 3A, second end 92a may have an angular orientated surface, at an angle A2, to a line defined by inner side 82 of handle 18. Angle A2 may be any angle between about zero (0) degrees and about forty-five (45) degrees, preferably between about five (5) and about twenty (20) degrees.

As further shown in FIG. 4A, head portion 26 has an outer surface 39b defined by a radius R1 and a width W3 in a radial direction inward from outer surface 39b. As shown in FIG. 4B, the head section 26 may have an overall thickness T9 similar to T7 of handle 24. As shown in FIG. 4B, head section 26 has an overall thickness T9 between a first surface 73b and a second surface 75b of head section 26 that may match T7 of the handle as shown or, alternatively, may be more or less than T7. Head section 26 includes at least three elements: a guide projection 66b, a flange notch 68b, and a connection wedge 70b which extends radially inward from the outer surface 39b. Guide projection 66b extends the furthest radially inward and its inner edge 72b is defined by radius R2. Guide projection 66b has a thickness of T10 that may be any thickness between about one-fourth (¼) to about three-fourths (¾) of T9. The inner edge 72b and outer edge 39b define width W6 in one embodiment.

Flange notch 68b is configured to receive a flange or a portion thereof for the applicable flange size for the diameters of components being separated. Flange notch 68b has a thickness T11 that may be any thickness between about one-fourth (¼) to about three-fourths (¾) of T9. Flange notch 68b has an interior surface 74b that is defined by a radius R3 as shown in FIG. 4A. The distance from the inner surface 72b of guide projection 66b to interior surface 74b may be also called the depth of the flange notch 68b.

Connection wedge 70b begins at a pointed edge 76b and has an inclined surface 78b extending from a pointed edge 76b upward and back toward the outer edge 39b at an angle α. Angle α may be any angle between zero (0) and ninety (90) degrees, preferably in a range between about thirty (30) to about sixty (60) degrees. The pointed edge 76b is defined at a radius R4 and may be proximate the flange notch 66b. Connection wedge 70b has a thickness or width T12 that may be any thickness between about one-fourth (¼) to about three-fourths (¾) of T9. When combined, T4, T5, and T6 may add up to T3. Radiuses R1, R2, R3, and R4 may share a common center point 80b and, therefore, may be substantially concentric. Radius center point 80b may be positioned a length LR₂ from end 48 of handle 24, and a height H3 from an inner side 84 of handle 24 on second section 14. Handle 24 also includes an outer side 85, wherein inner side 84 and outer side 85 defines width W4.

As further shown in FIG. 4A, radius center point 80b may also be located a length LA₄ from center point 88 of aperture 58. The distances LA₂ and LA₄ should be substantially identical so that head portion 20 aligns in an opposing relation and cooperates with head portion 26 when the seal-break pliers are assembled.

As further shown in FIG. 4A, head portion 26 includes a first end 90b and a second end 92b. As shown, first end 90b may have an angular orientated surface orientated at an angle A3 to a line defined by inner side 84 of handle 24. Angle A3 may be any angle between about zero (0) degrees and about forty-five (45) degrees, preferably between about five (5) and about twenty (20) degrees. Similarly, as shown in FIG. 4A, second end 90b may have an angular orientated surface, at an angle A4, to a line defined by inner side 84 of handle 24. Angle A4 may be any angle between about zero (0) degrees and about forty-five (45) degrees, preferably between about five (5) and about twenty (20) degrees.

In a preferred embodiment, head sections 20 and 26 are substantially identical. However, in another embodiment, one of head section 20 or head section 26 may simply have a flat bearing surface which engages the outer edge of flanges 110 and 114. Moreover, it is preferred that the lengths, thicknesses and widths of first section 12 and second section 14 are substantially the same, however, the present seal-break pliers shall not be limited to such embodiments.

As shown in FIG. 2., seal-break pliers 10 are assembled by inserting fastener 16 through aperture 58 of second section 14, positioning third side 47 of transition section 22 of first section 12 opposite and facing inner side 65 of transition section 28 of second section 14 and then inserting fastener 16 into or through apertures 40 and 58 of the sections 12 and 14. First section 12 and second section 14 are thereby pivotally coupled using fastener 16 so that moving or squeezing handles 18 and 24 toward each other results in head portions 20 and 26 moving toward each other in a “clamping” or constricting motion.

FIGS. 5 and 6 demonstrate the present seal-break pliers 10 in use. As shown in FIG. 5., a guide projection 66 extends inward past a connection wedge 70 so that guide projection may contact inclined surface 118a of flange 110 of first component 102 so that the end of flange 110 substantially aligns with flange notch 68 and pointed edge 76 is substantially aligned with seal 120 between bearing surfaces 116a and 116b. In this alignment position, handles 18 and 24 will be spread apart. A user or technician can grip the present seal-break pliers wherein the user's hand will typically engage outer surfaces 83 and 85 of handles 18 and 24 respectively.

A technician can then apply a constricting force to one or more of handles 18 and 24 by squeezing them together, which, as shown in FIG. 6, may displace each head portion 20 and 26 a distance X toward each other. In other words, the relative displacement of one handle toward the other handle results in the relative displacement of one head section toward the other head section. As head portions 20 and 26 displace inwardly, flange 110 is received into flange notch 68a and 68b. Connection wedge 70a and 70b then engages the bearing surface 116b of flange 114. As connection wedge 70a and 70b translates inwardly, it wedges flange 110 and flange 114 apart a distance Y, thereby breaking the seal. The distance Y will be related to distance X and angle α. Because connection wedge 70a and 70b are configured to engage a significant circumferential portion of flanges 110 and 114, there is no localized damage to the flanges 110 and 114. Localized damage of the flanges 110 or 114 often results from point-pry locations that are inherent in the use of a hammer or screw-driver to separate the pieces and often renders these components unusable for future use because the flange is damages and will not withstand the high-temperature and high-pressure conditions in which these components are used. This provides a substantial improvement in the art because no localized damage is present after separating the parts and these components may be reused in a re-assembled or re-configured system. To date, persons of skill in the art have failed to develop or utilize such a tool to separate the pipe sections.

The above figures and descriptions illustrate the elements for the present seal-break pliers. A person of skill in the art will appreciate that the lengths, thicknesses, widths, and radiuses described above can be easily determined to size an embodiment of the present seal-break pliers for use with common piping sizes and corresponding flange diameters. Typically, pipe diameters range from one-half (½) inch to six (6) inches. However, any pipe diameter and corresponding flange diameter is within the scope of the present invention. Moreover, similar layouts and configurations are also applicable to non-standard pipe shapes, diameters or piping configurations. The present seal-break pliers may be made from any metal or plastic with material properties that are capable of having the strength and rigidity required, wherein the seal-break pliers may be machined, cast, molded or any other fabrication technique.

As is evident from the foregoing description, certain aspects of the present invention are not limited to the particular details of the examples illustrated herein. It is therefore contemplated that other modifications and applications using other similar or related features or techniques will occur to those skilled in the art. It is accordingly intended that all such modifications, variations, and other uses and applications which do not depart from the spirit and scope of the present invention are deemed to be covered by the present invention.

Other aspects, objects, and advantages of the present invention can be obtained from a study of the drawings, the disclosures, and the appended claims.

We claim:

1. A seal-break pliers to separate components in food processing, chemical, or pharmaceutical manufacturing or processing system, the seal-break pliers comprising:
a first section having a first handle, a first head section, and a first transition section disposed and angularly orientated between the first handle and the first head section;
a second section having a second handle, a second head section, and a second transition section disposed and angularly orientated between the second handle and the second head section;
a fastener to pivotally couple the first transition section of a first section to the second transition section of the second section such that displacing the first and second handles toward each other results in an relative movement of the head sections toward each other; and
wherein said first and said second head portions each include a guide projection, a flange notch adjacent to the guide projection, and a wedge projection adjacent to the flange notch.

2. The seal-break pliers of claim 1 wherein each of said wedge projections includes a pointed edge proximate said flange notch and an inclined surface extending away from said pointed edge and toward an outer edge of said head section, wherein said inclined surface intersects a second surface of said head section at an angle.

3. The seal-break pliers of claim 2 wherein said angle is in a range between about thirty degrees and sixty degrees.

4. The seal-break pliers of claim 4 wherein said angle is around forty-five degrees.

5. The seal-break pliers of claim 1 wherein each of said flange notch has a thickness and depth capable to receive a portion of a flange of a component.

6. The seal-break pliers of claim 1 wherein said guide projection, said flange notch, and said wedge projection of each head section share a common radius center point, and wherein the radius to an inner edge of the guide projection is less than the radius to a pointed edge of the wedge projection.

7. The seal-break pliers of claim 1, wherein said first transition section is angularly orientated between the first handle and the first head section at an angle in a range between about thirty and about sixty degrees.

8. The seal-break pliers of claim 7, wherein said second transition section is angularly orientated between the second handle and the second head section at an angle in a range between about thirty and about sixty degrees.

9. The seal-break pliers of claim 1, wherein each of said head section includes a first end and a second end, and wherein said first end has a surface orientated relative to an inner side of the respective handle at an angle, wherein said angle is in a range between about five and about twenty degrees.

10. The seal-break pliers of claim 10, wherein said second end has a surface orientated relative to an inner side of the respective handle at an angle, wherein said angle is in a range between about five and about twenty degrees.
